(19) United States
(12) Patent Application Publication
(10) Pub. No.: US 2024/0005146 A1
(43) Pub. Date: Jan. 4, 2024

(54) EXTRACTION OF HIGH-VALUE SEQUENTIAL PATTERNS USING REINFORCEMENT LEARNING TECHNIQUES

(71) Applicants: Adobe Inc., San Jose, CA (US); Delhi Technological University, New Delhi (IN)

(72) Inventors: Tanay Anand, Uttar Pradesh (IN); Piyush Gupta, Uttar Pradesh (IN); Pinkesh Badjatiya, Madhya Pradesh (IN); Nikaash Puri, Uttar Pradesh (IN); Jayakumar Subramanian, Uttar Pradesh (IN); Balaji Krishnamurthy, Uttar Pradesh (IN); Chirag Singla, Delhi (IN); Rachit Bansal, Delhi (IN); Anil Singh Parihar, Delhi (IN)

(21) Appl. No.: 17/855,085

(22) Filed: Jun. 30, 2022

(51) Int. Cl. G06N 3/08; G06N 3/04

(52) U.S. Cl. CPC G06N 3/08; G06N 3/0445

(57) ABSTRACT

In some embodiments, techniques for extracting high-value sequential patterns are provided. For example, a process may involve training a machine learning model to learn a state-action map that contains high-utility sequential patterns; extracting at least one high-utility sequential pattern from the trained machine learning model; and causing a user interface of a computing environment to be modified based on information from the at least one high-utility sequential pattern.

### TECHNICAL FIELD

This disclosure relates generally to artificial intelligence. More specifically, but not by way of limitation, this disclosure relates to extraction of sequential patterns using predictive models trained using reinforcement learning techniques.

### BACKGROUND

With the advent of technology, more and more data is being generated and collected at data centers. An entity (e.g., a company) may have a large store of data that represents records of system interaction events that occur across its communication channels, which may include, for example, one or more websites, mobile websites, and/or apps, etc.

### SUMMARY

Certain embodiments involve extracting high-value sequential patterns using predictive models trained using reinforcement learning techniques. In some embodiments, for example, a pattern-mining computing system is configured to train a machine learning model to learn a state-action map (e.g., a policy) that contains high-value sequential patterns. During the training, the pattern-mining computing system generates a plurality of sequential patterns and matches the generated sequential patterns to recorded sequences of system interaction events. Based on the matched recorded sequences, the pattern-mining computing system calculates rewards for the generated sequential patterns and updates the machine learning model based on the rewards. The pattern-mining computing system further extracts at least one high-value sequential pattern from the trained model, and, in some cases, causes a user interface of a computing environment to be modified based on information from the at least one high-value sequential pattern.

The pattern-mining computing system according to such an embodiment may include a reinforcement learning server having an agent module that uses the machine learning model being trained to generate the sequential patterns and an environment module that identifies the matching sequences from a data store. The environment module may apply a custom utility measure to the matching sequences to calculate corresponding rewards, and the agent module may use the sequential patterns and the calculated rewards to train the machine learning model to learn a policy that contains high-value sequential patterns according to the custom utility measure.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 depicts an example of a computing environment in which a pattern-mining computing system employs a reinforcement-learning server to train a machine learning model to learn a policy that contains high-utility sequential patterns and a pattern-extracting server to extract high-utility sequential patterns from the trained machine learning model, and an interface-modification server modifies a user interface of the computing environment based on the extracted high-utility sequential patterns, according to certain embodiments of the present disclosure.

FIG. 2 depicts a block diagram of a reinforcement learning server, according to certain embodiments of the present disclosure.

FIG. 3 depicts a flow diagram for generating a sequential pattern, according to certain embodiments of the present disclosure.

FIG. 4 depicts a block diagram of a machine learning model that includes a long-short-term memory network and a Q-network, according to certain embodiments of the present disclosure.

FIG. 5 depicts a flow diagram for extracting high-value sequential patterns from a trained machine learning model, according to certain embodiments of the present disclosure.

FIG. 6 depicts an implementation of a process block for training a machine learning model to learn a state-action map that contains high-utility sequential patterns, according to certain embodiments of the present disclosure.

FIG. 7 depicts an example of a computing system for implementing certain embodiments of the present disclosure.

### DETAILED DESCRIPTION

Techniques described herein include using reinforcement learning to train a model to learn a policy that contains high-value sequential patterns, wherein the value of a sequential pattern is based on a custom utility measure (e.g., a user-defined measure of interestingness). The custom utility measure (or function) maps a sequential pattern to a utility value (e.g., between zero and one). One non-limiting example of the custom utility function is the total revenue/total quantity of items (e.g., products) purchased in a sequence.

During training, an agent module uses the machine learning model being trained to generate sequential patterns, and an environment module identifies matching sequences from a data store. The environment module applies the custom utility measure to the matching sequences to calculate corresponding rewards, and the agent module uses the sequential patterns and the calculated rewards to train the machine learning model to learn a policy that contains high-value sequential patterns. The trained model is then searched (e.g., using a tree-based depth-first-search procedure) to extract high-value sequential patterns from the learned policy.

By identifying sequential patterns that maximize a custom utility measure with respect to the data store, techniques described herein enable a practitioner to examine types of behavior that lead to such outcomes and possibly to modify a user interface of the computing environment (e.g., of one or more communication channels) to encourage such behavior. For example, such techniques may include causing the user interface to be modified to deliver content to promote desired sequences of customer actions (e.g., to change the layout of a website, to deliver promotional messages in a particular manner or sequence, etc.). Techniques as described herein are portable to other reporting applications as well, examples of which include data analytics, web experience management, etc.

As described herein, certain embodiments provide improvements to online resource management by solving problems that are specific to online platforms. Examples of online resources include websites and other user interfaces to an interactive computing environment, which may be hosted on one or more web servers, mobile web servers, or app servers. It may be desired to reconfigure or otherwise modify a user interface to an interactive computing environment (e.g., to modify a website or other communication channel) to operate more efficiently and/or to optimize one or more identified performance metrics. Network throughput may be increased, for example, by modifying a website in order to reduce an average response time for one or more of its web pages. Network bandwidth consumption may be reduced, for example, by modifying a website to reduce the number of web pages of the website that a user must visit in order to reach a particular destination web page. Such modifications may be guided by an analysis of traffic to the website (e.g., web log data) to determine patterns and statistics that characterize the website's operation.

Because this resource configuration problem is specific to online resources, embodiments described herein utilize automated models that are uniquely suited for online resource management. To support meaningful traffic analysis and interface modification, a machine learning model that is trained by the reinforcement learning server can be utilized by the pattern-mining computing system to identify high-value sequential patterns within a large data store. Consequently, certain embodiments more effectively facilitate configuration of online resources, as compared to existing systems.

As used herein, the term “online platform” is used to refer to an interactive computing environment, hosted by one or more servers, that includes various interface elements with which user devices interact (e.g., via one or more communication channels). For example, clicking or otherwise interacting with one or more interface elements during a session causes the online platform to manipulate electronic content, query electronic content, or otherwise interact with electronic content that is accessible via the online platform.

As used herein, the term “website” is used to refer to a traditional website (e.g., for access via a personal computer) or to a mobile website (e.g., having content that scales to fit the screen size of the client device, such as a tablet or smartphone). As used herein, the term “communication channel” is used to refer to a website, which may include multiple web pages, or to an application executing on an app server for communication with a dedicated software application installed on a client device (a “native application” or “app”) or with a web application (“web app”) executing within a browser on a client device.

As used herein, the term “click event” is used to refer to a request for online resources (e.g., a request for a web page, an HTTP request) that is received over one or more of the communication channels from a user of a web browser, a native app, or a web app. Such events are referred to collectively as “click activity,” and records of such activity are referred to as “click log data.” The term “record of click activity” is used to refer to a record that indicates the resource requested (e.g., the web page or other HTTP resource) and the requesting user (e.g., the user's IP address and/or other identifying feature) and may also indicate further information, such as, for example, any one or more of the time of the request, the user's browser and/or device type, which page features the user engaged, geographical information of the user, the website that referred the user, etc. The term “click log data” is used to refer to a collection of records of click activity.

As used herein, the term “interaction data” is used to refer to data generated by one or more user devices interacting with an online platform that describes how the user devices interact with the online platform. An example of interaction data is clickstream data. Clickstream data can include one or more data strings that describe or otherwise indicate data describing which interface features of an online service were “clicked” or otherwise accessed during a session. Examples of clickstream data include any consumer interactions on a website, consumer interactions within a local software program of a computing device, information from generating a user profile on a website or within a local software program, or any other consumer activity performed in a traceable manner.

As used herein, the term “system interaction event” is used to refer to an interaction by a user with an online platform (e.g., a click event) or an interaction by an online platform with a user (e.g., a promotional e-mail, text, or other message). Examples of a system interaction event include a purchase event, a webpage view event, etc. A system interaction event may be time-stamped and may have multiple dimensions (e.g., webpage visited, location of the link on the page, price of an item (e.g., product), quantity of an item being purchased, etc.).

As used herein, the term “sequential pattern” is used to refer to a time-ordered sequence of system interaction events, which may be time-stamped. A sequence of time-stamped system interaction events that is associated with a corresponding user is also called a “journey” or “session.” Within a data store, the end of a recorded session is indicated by a termination event (e.g., the user logging out) or by a specified period (e.g., five, ten, twenty, or thirty minutes) of inactivity by the user. As used herein, the terms “high-value sequential pattern” and “high-utility sequential pattern” are used synonymously to refer to a sequential pattern that has a high value according to a specified utility measure. As used herein, the term “episode” is used to refer to generation of a sequential pattern and calculation of a corresponding reward.

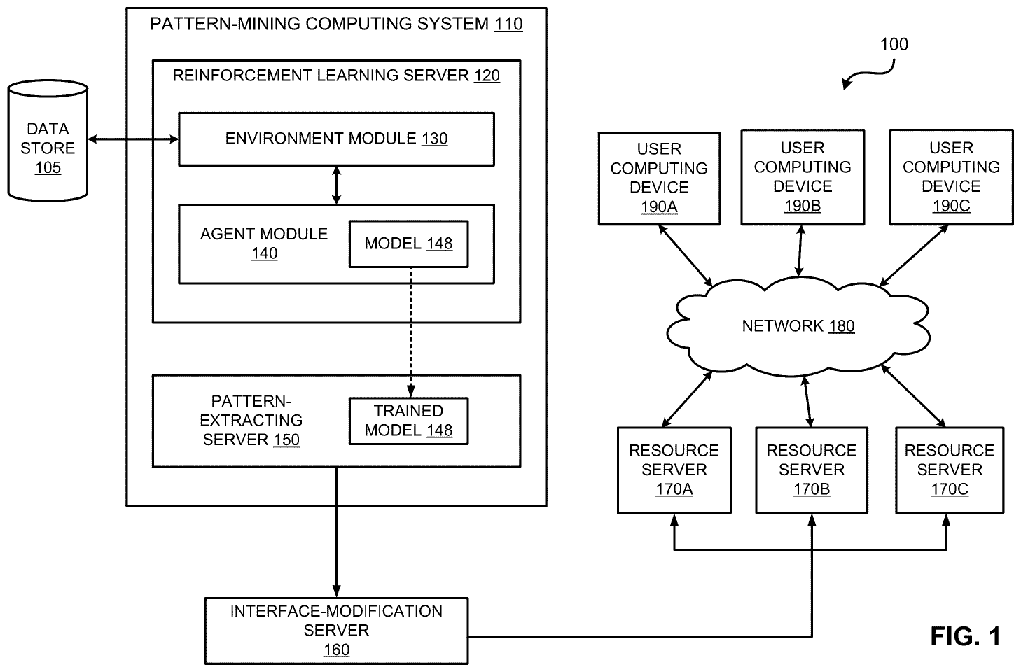

Referring now to the drawings, FIG. 1 is an example of a computing environment 100 in which a pattern-mining computing system employs a reinforcement learning server to train a machine learning model, based on records from a data store, and a pattern-extracting server to extract high-utility sequential patterns from the trained machine learning model, according to certain embodiments of the present disclosure. The computing environment 100 also includes an interface-modification server to modify a user interface of the computing environment.

In various embodiments, the computing environment 100 includes a pattern-mining computing system 110, a data store 105, an interface-modification server 160, and one or more resource servers 170A-170C (which may be referred to herein individually as a resource server 170 or collectively as the resource servers 170).

The interface-modification server 160 is configured for modifying a user interface to various resources hosted on the resource servers 170 that may be accessed by one or more user computing devices 190A-190C (which may be referred to herein individually as a user computing device 190 or collectively as the user computing devices 190).

The resource servers 170 host an online interactive computing environment through which various types of resources can be accessed, such as computing resources, data storage resources, digital content resources and the like. Computing resources may be available as virtual machines configured to execute applications, such as Web servers, application servers, or other types of applications. For example, the resource servers 170 may host one or more of an entity's websites, each of which include web pages that provide information to users about the entity and/or its products via the online interactive computing environment. A website may be a traditional website (e.g., for access via a personal computer) or a mobile website (e.g., having content that scales to fit the screen size of the client device, such as a tablet or smartphone). Additionally or alternatively, the resource servers 170 may host one or more of an entity's other consumer communication channels. For example, the resource servers 170 may include one or more servers that provide content to native applications (apps) and/or web applications (web apps). Examples of data storage resources include single storage devices, a storage area network, and so on. Digital content resources may include any type of digital contents, such as images, audio, video, files, web pages, emails, text, and the like.

User computing devices 190 can access the online resources through a network 180. For example, a user can employ a user computing device 190 to access, via the online interactive computing environment, one or more websites hosted on the resource servers 170. The user computing device 190 can access the resources in a pull mode or a push mode. In the pull mode, a user computing device 190 connects to the resource server 170 and proactively requests certain content. In the push mode, the resource server 170 sends certain content or recommendation for content to the user computing device 190 without an explicit request from the user computing device 190. In either mode, the request for content, the recommendation for the content, the interactive content or the content itself can be sent though the network 180, which may be a local-area network (LAN), a wide-area network (WAN), the Internet, or any other networking topology known in the art that connects the user computing device 190 to the resource servers 170.

The pattern-mining computing system 110 includes a reinforcement learning server 120 and a pattern-extracting server 150. The reinforcement learning server 120 accesses a data store 105 that contains records of system interaction events that have occurred over time (e.g., across an entity's communication channels) and are associated with corresponding users. The system interaction events may include click events by users of the communication channels (e.g., click log data). Alternatively or additionally, the system interaction events may include entity-initiated communications (e.g., promotional e-mails or text messages) that are sent to users. Based on information from the data store 105, the reinforcement learning server 120 trains a machine learning model 148 to learn a state-action map (e.g., a policy) that contains high-value sequential patterns.

The reinforcement learning server 120 includes an environment module 130 and an agent module 140. Based on predictions by the machine learning model 148, the agent module 140 generates sequential patterns that describe corresponding sequences of system interaction events. The environment module 130 queries the data store 105 to identify recorded sequences that match the generated sequential patterns and calculates corresponding rewards (e.g., according to a user-defined utility function). The agent module 140 trains the machine learning model 148 to learn a state-action map (e.g., a policy) that contains high-value sequential patterns by updating the model based on the rewards.

The state space of the agent module 140 is the space of all possible sequential patterns (including the empty sequence), and the current state of the agent module 140 is the sequential pattern currently being generated. The action space of the agent module 140 includes all possible system interaction events (including the stop action as described herein), and the next-action is the system interaction event to be appended to the current state to generate the next state of the agent module 140.

The pattern-extracting server 150 extracts at least one high-utility sequential pattern from the trained machine learning model 148, and the interface-modification server 160 can be configured to cause a user interface of the computing environment to be modified based on information from the at least one high-utility sequential pattern. One or more of the resource servers 170A,B,C implement the user interface, and users of the user computing devices 190A,B,C may interact with the user interface via network 180. For example, the interface-modification server 160 can be configured to modify a user interface to an online computing environment hosted on the resource servers 170 based on information from the at least one high-utility sequential pattern.

An entity (e.g., a company) may have a large store of data that represents records of system interaction events that occur across its communication channels. The records include sequences of system interaction events that occur over time and are associated with corresponding users. The system interaction events may include click events (e.g., requests for online resources, such as requests for web pages or HTTP requests) that are received over the communication channels from users of web browsers, native apps, or web apps. For example, a sequence of system interaction events may indicate the path that a user has taken while navigating through the entity's website(s). Alternatively or additionally, the system interaction events may include communications to users that are initiated by an online resource (e.g., entity-initiated communications that are sent to users) such as, for example, promotional e-mails, text messages, or app notifications. For example, another sequence of system interaction events may indicate a series of promotional e-mails that have been sent to a user and any responses to such e-mails (e.g., click-through events) by the user.

It may be desired to mine the data store to identify certain types of sequences of system interaction events among the recorded observations. For example, a marketer may wish to identify sequential patterns of customer actions in which high dollar value items (e.g., products) were purchased, or sequential patterns of promotional e-mails in which a high click-through rate was achieved. Identification of such sequential patterns may be used to modify a user interface of the system to increase an incidence of the target results.

Unfortunately, the sequential pattern space is usually exceedingly large and impracticable to search. The data store may contain millions of recorded system interaction events, representing activity by many thousands or more of different users. The length of each sequence of system interaction events within these records is typically arbitrarily long, and for each event in a sequence, the number of possibilities for the next event in the sequence is usually at least ten and may be one hundred or more.

For some measures of interestingness, it is possible to prune the search space. For example, a data store may be searched for most-frequent sequences by exploiting the principle that if a particular sequence is infrequent in the data store, then any sequence that contains the particular sequence must also be infrequent and need not be searched. This principle is an example of the downward closure property (also called anti-monotonicity), which may be stated as follows: the support of an item set A is less than a threshold B, if the support of any subset of the item set A is less than the threshold B. For some other measures of interestingness, a pre-existing hierarchy among the possible items may be exploited in a similar manner to prune the search space.

Many significant measures of interestingness do not fall within these limited classes and are not anti-monotonic, however, so that such pruning methods are ineffectual. Methods for identifying high-value sequences of commercial interest (for example, sequential patterns of customer actions in which high dollar value items (e.g., products) were purchased, or sequential patterns of promotional e-mails in which a high click-through rate was achieved) within a data store that is large enough to be useful remain elusive.

Techniques described herein use reinforcement learning to train a machine learning model to learn a policy that contains high-value sequential patterns (e.g., according to a user-defined utility measure). The trained machine learning model is then searched to extract high-value sequential patterns from the learned policy. Exploiting the information that is obtained by exploring the state space in such manner drastically reduces the collection of sequences to be searched.

By identifying sequential patterns that maximize a custom utility measure with respect to the data store, techniques described herein enable a practitioner to examine types of behavior that lead to such outcomes and possibly to modify a user interface of the computing environment (e.g., of one or more communication channels) to encourage such behavior. For example, such techniques may include causing the user interface to be modified to deliver content to promote desired sequences of customer actions (e.g., to change the layout of a website, to deliver promotional messages in a particular manner or sequence, etc.). Techniques as described herein are portable to other reporting applications as well, examples of which include data analytics, web experience management, etc.

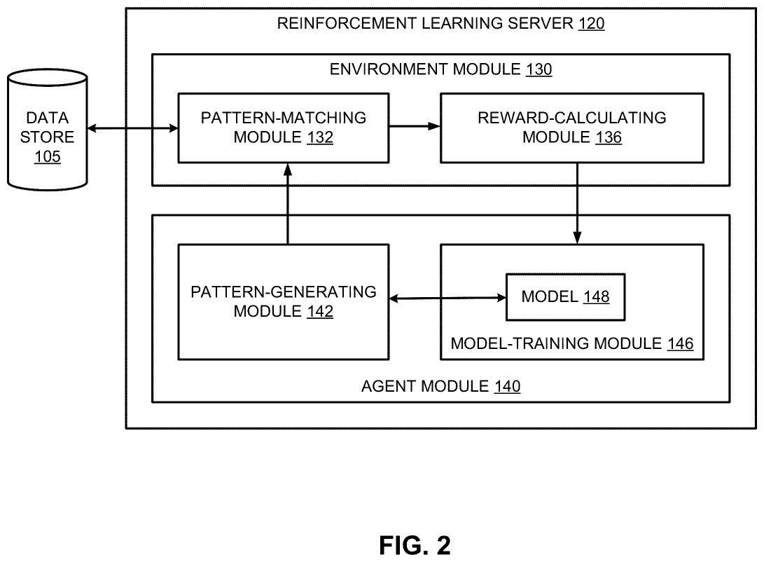

FIG. 2 shows a diagram of an implementation of the reinforcement learning server 120, according to certain embodiments of the present disclosure. In this example, the agent module 140 includes a pattern-generating module 142 and a model-training module 146, and the environment module 130 includes a pattern-matching module 132 and a reward-calculating module 136. The pattern-generating module 142 uses next-action predictions from the machine learning model 148 to generate sequential patterns, and the pattern-matching module 132 queries the data store 105 to obtain recorded sequences that match the generated sequential patterns. Based on the recorded sequence(s) and a specified utility function, the reward-calculating module 136 calculates rewards for the corresponding generated sequential patterns, and the model-training module 146 trains the machine learning model 148 based on the generated sequential patterns and the corresponding rewards.

The model-training module 146 may train the machine learning model 148 to predict, for an input state, a Q-value for each possible next action. A Q-function (also called a state-action value function) is a reinforcement learning algorithm that estimates how to act optimally. Formally, given a state and an action, the Q-function returns the expected (discounted) cumulative reward that will be obtained in the future if the given action is taken in the given state and an optimal policy is followed subsequently. In other words, the Q value represents the maximum reward obtainable from the current state if a specified action is taken. Once training of the machine learning model 148 is complete (e.g., once episodic rewards become stable), the machine learning model 148 has learned a policy or state-action map that returns the expected discounted future reward Q(s, a) for taking action a in state s.

The pattern-generating module 142 generates each sequential pattern iteratively by initializing the sequential pattern to the empty sequence, providing the sequential pattern for the current iteration (e.g., the sequential pattern as generated so far) to the machine learning model 148 to obtain a next-action prediction, and appending a selected next-action to the sequential pattern to obtain the sequential pattern for the next iteration. The generated sequential pattern is complete when it ends with the stop action, and the iterative procedure terminates.

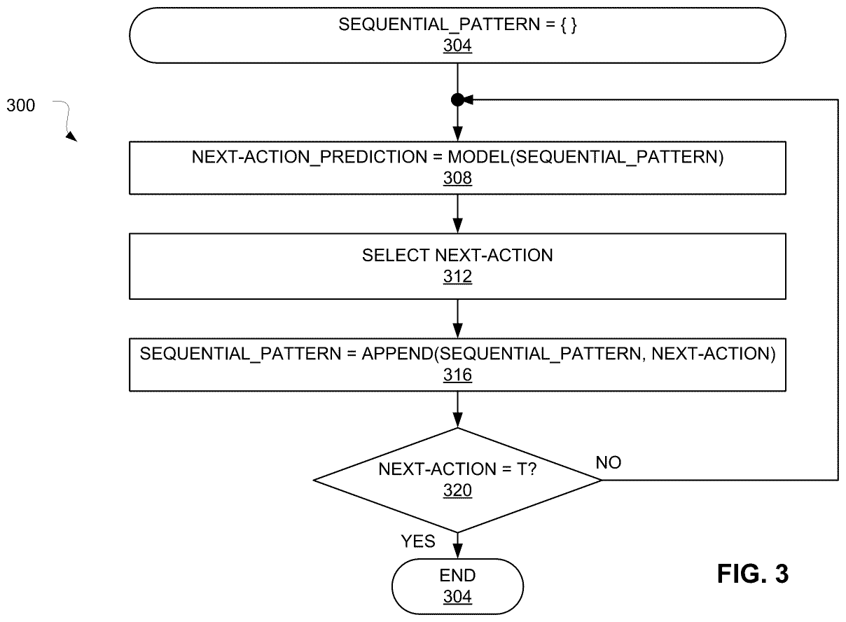

FIG. 3 depicts an example of a process 300 for generating a sequential pattern, according to certain embodiments of the present disclosure. One or more computing devices (e.g., the pattern-mining computing system 110) implement operations depicted in FIG. 3 by executing suitable program code. For example, process 300 may be executed by the pattern-generating module 142. Respective instances of process 300 may be executed (e.g., in serial or parallel) to generate each of the plurality of sequential patterns. For illustrative purposes, the process 300 is described with reference to certain examples depicted in the figures. Other implementations, however, are possible.

At block 304, the process involves initializing the sequential pattern to the empty sequence. At block 308, the process involves providing the sequential pattern as input to the machine learning model 148 to obtain a next-action prediction. The machine learning model 148 may be configured, for example, to generate a next-action prediction vector, where each element of the vector corresponds to a respective one of the possible next-actions (system interaction events and the stop action) and indicates a predicted optimal Q-value for taking that action in the current state.

At block 312, the process involves selecting a next-action. The selection may be performed according to a strategy of exploration (e.g., exploring the action space by selecting the next-action at random from among the possible next-actions) or a strategy of exploitation (e.g., exploiting the ongoing training of the model parameters by selecting the output next-action that has the highest predicted Q-value in the next-action prediction vector). In one example, the process involves selecting the next-action at block 312 according to an epsilon-greedy algorithm, in which a random value between 0 and 1 is generated and compared to a predetermined value ‘epsilon.’ If the random value does not exceed epsilon, the next-action is selected at random from among the possible next-actions, and otherwise the output next-action that has the highest predicted Q-value in the next-action prediction vector is selected. The value of epsilon may be decreased over time (for example, as training progresses) so that the pattern-generating module 142 tends to exploit the ongoing training of the machine learning model parameters rather than to explore the selection space of next-actions randomly.

At block 316, the process involves appending the selected next-action to the sequential pattern to obtain the sequential pattern for the next iteration. At block 320, if the selected next-action is the stop action (indicated as T), then the generated sequential pattern is complete and the process terminates; otherwise, the process continues to block 308 for the next iteration.

The environment module 130 includes a pattern-matching module 132 and a reward-calculating module 136. For each sequential pattern generated by the pattern-generating module 142, the pattern-matching module 132 matches the sequential pattern to one or more recorded sequences in the data store 105. In one example, the data store 105 is implemented as a database, and the pattern-matching module 132 queries the data store 105 to obtain one or more recorded sequences that match the generated sequential pattern using a SELECT query. If no such recorded sequence is found for the generated sequential pattern, the episode terminates.

Based on the recorded sequence(s) and a specified utility function (e.g., as provided by a practitioner), the reward-calculating module 136 calculates a reward. For example, the reward-calculating module 136 may apply the utility function to each of the one or more matching recorded sequences to calculate a corresponding utility value and may calculate the reward as a function (e.g., an average) of the utility values. The utility function may be any arbitrary or custom utility function as specified by the practitioner. One non-limiting example of the specified utility function is the average revenue per item purchased (total revenue divided by total quantity of items purchased) in a sequence.

The reward-calculating module 136 provides the reward to the model-training module 146, which trains the machine learning model 148 based on the reward and the corresponding generated pattern (e.g., as received from the pattern-generating module 142 or from the environment module 130). The model-training module 146 may perform training of the machine learning model 148 in batches (e.g., after each batch of episodes) or may use gradient accumulation to achieve a higher effective batch size.

As described above, the environment module 130 queries the data store 105 and calculates a corresponding reward only for generated sequential patterns that are terminated (e.g., for which the stop action is reached). In an alternative implementation, the environment module 130 queries the data store 105 for recorded sequences matching the sequential pattern being generated at each action. For some actions (e.g., webpage views), however, there may be no reward under the utility function being used (e.g., purchase-based utility).

The model-training module 146 uses the generated sequential patterns and the corresponding rewards to train the machine learning model 148 to learn a policy that contains high-value sequential patterns. The machine learning model 148 can be any machine learning model configured to accept generated sequential patterns as inputs and to generate predicted next-actions as outputs. For example, the machine learning model 148 can be a logistic regression model, a naive Bayes model, a neural network (e.g., a deep neural network or DNN), or another type of machine learning model. The model-training module 146 may be configured to iteratively adjust the parameters of the machine learning model 148, based on the generated sequential patterns and the corresponding rewards, so that the machine learning model 148 learns a state-action map that contains high-value sequential patterns. The model-training module 146 may perform training after each batch of episodes or may use gradient accumulation to achieve a higher effective batch size.

The machine learning model 148 may be implemented as a deep-Q-network (DQN), in which the Q function is represented using a DNN. The weights of this network are learned by minimizing the Bellman residual error, which is the difference between the predicted Q-value and the Q-value estimated using data sampled from the environment. Such learning differs from standard supervised learning in that the target here (i.e., the estimated Q-value) also uses the Q function being learned, which may lead to a problem of moving targets. To stabilize the learning in this setting, multiple steps such as use of a separate target Q function (which is a historical copy of the Q function being learned), use of replay buffers, and uniform sampling with different batch-sizes may be used.

A DQN implementation of the machine learning model 148 may use a separate target Q function (a historical copy of the Q function being learned) to address the problem that updating the network causes the target Q value to move (correlation of the model weights with the target Q value). For example, the model-training module 146 may clone the prediction network Q at every C-th update to obtain a target network Q′ and use the cloned target network Q′ to generate the target Q values for the following C updates to the prediction network Q.

A DQN implementation of the model 148 may use experience replay to remove correlations in the observation. For example, the model-training module 146 may store the last N experience tuples in a replay buffer (where each experience tuple includes [current state, action, reward, next state]) and sample uniformly at random from the replay buffer when performing updates.

The machine learning model 148 may be implemented as a deep recurrent Q-network (DRQN). In such case, the machine learning model 148 may use a recurrent neural network in order to construct a state from the entire history of observations (e.g., instead of just the current observation). DRQN may be used for situations in which the state of a system is only partially observed. For cases in which the state of a system is fully observable, the observations and the state are identical. However, for cases in which the state of the system is not fully observed, the entire observation history at any point in time can be considered as an equivalent state. Hence, a DRQN implementation of the machine learning model 148 may use the entire observation history as an equivalent state. To make computations using this entire history feasible, a recurrent neural network is used as a function approximator.

In general, it is possible that each system interaction event consists of several attributes (dimensions). For instance, a purchase event may consist of the category of the item purchased, the dollar value of the purchase, the cost-of-goods-sold (COGS) of the item purchased, etc. Other examples of system interaction event attributes include page type, time stamp, date, time spent on the page, customer identifier, type of click event (e.g., view, conversion, etc.), name of the item, sub-category of the item, price of the item, total price of all items in the basket, total number of all items in the basket, number of distinct items in the basket, and view time. In such situations, the sequential pattern consists of a sequence of system interaction events in which each event consists of a collection of attributes.

To handle sequences of system interaction events in which each event consists of more than one dimension, the machine learning model 148 may include a long short-term memory (LSTM) network at the input to the Q-network. The LSTM network takes a sequence of variable length as its input, and it produces as an output a fixed-length sequence that incorporates information from the variable-length input. For example, if the input to the LSTM network is a sequential pattern consisting of four system interaction events, the output of the LSTM network would have the same number of dimensions as if the input to the LSTM network had been a sequential pattern consisting of six system interaction events.

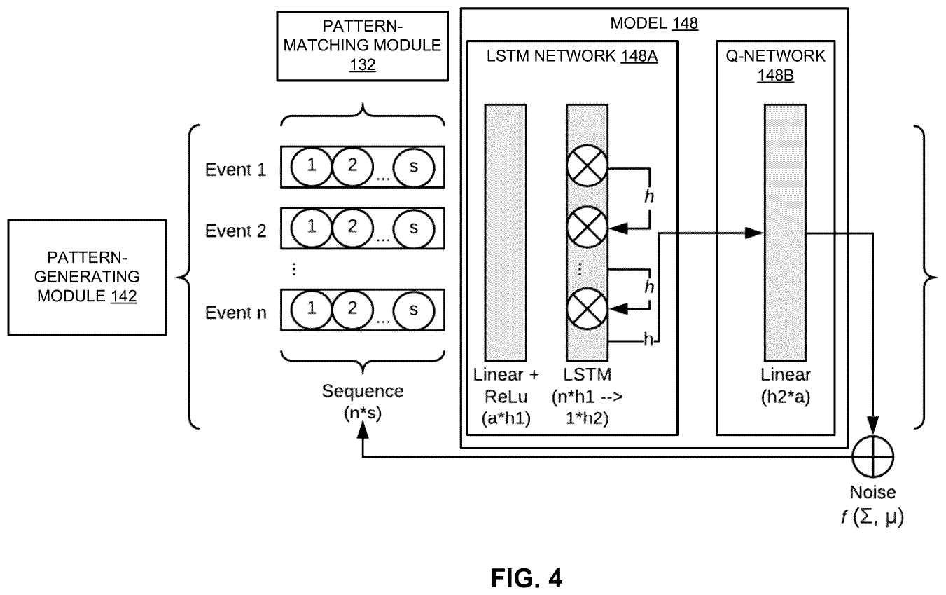

FIG. 4 shows an example of the model 148 that includes an LSTM network 148A which provides a condensed representation of a sequence of n multi-dimensional system interaction events (each having s dimensions) to the Q-network 148B, according to certain embodiments of the present disclosure. The output of the LSTM network 148A is a single embedding vector that is input to the Q-network 148B as the state of the machine learning model 148. For example, an input of {[1,2,3], [3,2,4], [5,6,1] } to the LSTM network 148A may give an output embedding of [2.113, 4.32, 6.778, 9.323]. The output embedding generated by the LSTM network 148A is used as the input for the Q-network 148B of the machine learning model 148.

For a case in which each system interaction event is single-dimensional, the output of the machine learning model 148 is also one-dimensional, such that the machine learning model 148 maps the input embedding to a single action. However, when each system interaction event consists of several attributes, then the action space of the agent module 140 is multi-dimensional, and the Q-network of the machine learning model 148 generates an output for each attribute of the system interaction event.

In the multi-dimensional case, the machine learning model 148 has multiple outputs (e.g., one for each dimension). The machine learning model 148 may be implemented to generate an event that has multidimensional outputs in any of several different ways. In one such example, the Q-network of the machine learning model 148 is implemented as a common core network followed by individual layers that are separate for each dimension of the action to be generated. In another such example, the model-training module 146 trains the Q-network of the machine learning model 148 to take state and action as input (e.g., the model-training module 146 trains the Q-network as a Q(s, a) network to predict the value of taking action a in state s). In this case, if the LSTM network of the machine learning model 148 outputs a vector having four dimensions (state vector) and the number of dimensions of each event is two, for example, then the length of the input to the Q(s, a) network of the machine learning model 148 is six (four from the state vector, plus two because each action to be processed has two dimensions).

Once the machine learning model 148 has been trained, the reinforcement learning server 120 has explored the large space of candidate sequences, and the machine learning model 148 has learned a policy that distinguishes sequential patterns that have high utility from sequential patterns that do not. The pattern-extracting server 150 extracts high-utility sequential patterns from the learned policy. For example, the pattern-extracting server 150 may use a tree-based depth-first-search (DFS) algorithm and a priority queue of length K to search the trained machine learning model 148 for the top-K highest-utility terminated sequential patterns.

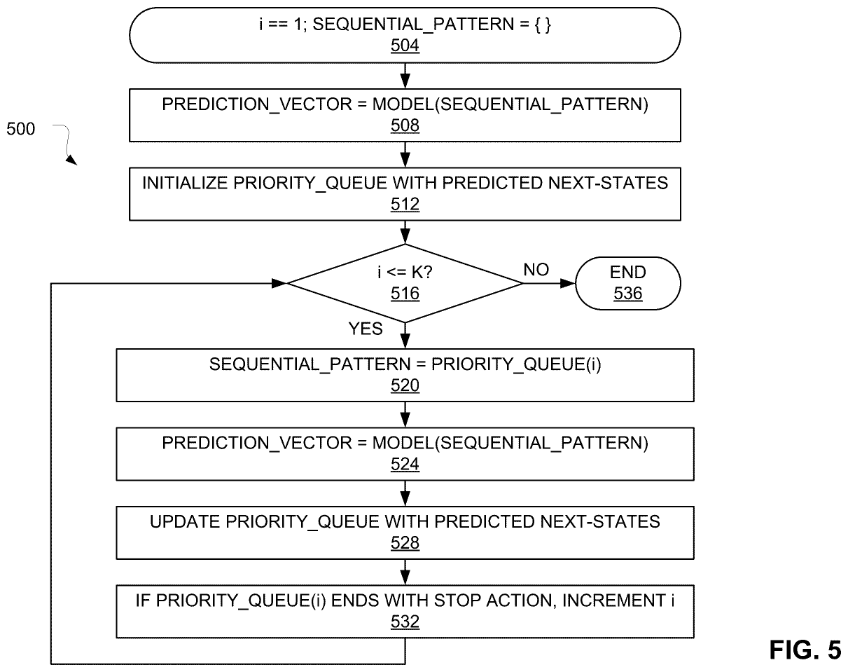

FIG. 5 shows a flowchart for a DFS process 500 that uses a priority queue of length K to extract a set of top-K high-utility sequential patterns from the trained machine learning model 148, according to certain embodiments of the present disclosure. One or more computing devices (e.g., the pattern-mining computing system 110, the pattern-extracting server 150) implement operations depicted in FIG. 5 by executing suitable program code.

At block 504, the process involves initializing a loop parameter i (e.g., to the value one) and initializing a sequential pattern (the current state) to the empty sequence. At block 508, the process involves providing the sequential pattern as input to the trained machine learning model 148 to obtain a corresponding next-action prediction vector. At block 512, the process involves initializing the priority queue with the K next-actions from the next-action prediction vector which have the highest predicted Q-values (e.g., by enqueuing these events as sequences of length one).

At block 516, the process involves iterating until the value of the loop parameter i is greater than K. Occurrence of this condition indicates that the K sequences enqueued on the priority queue are a set of top-K sequential patterns as learned by the trained machine learning model 148.

At block 520, the process involves updating the sequential pattern (the current state) to the i-th sequence enqueued on the priority queue. At block 524, the process involves providing the current sequential pattern as input to the trained machine learning model 148 to obtain a corresponding next-action prediction vector.

At block 528, the process involves updating the priority queue with next-actions from the next-action prediction vector which have the highest predicted Q-values. For example, if the Q-value of the next-action having the highest predicted Q-value is not less than the lowest Q-value among the sequences enqueued on the priority queue, then the corresponding next state is obtained by appending the next-action to the current state, and the priority queue is updated to enqueue this next state. The Q-value of the next-action having the next highest predicted Q-value is processed similarly (and so on) until a next-action Q-value that is less than the lowest Q-value among the sequences enqueued on the priority queue is encountered.

At block 532, the process involves determining whether the i-th sequence enqueued on the priority queue ends with the stop action, and if so, incrementing the loop parameter i. After block 532, the process involves returning to block 516. The process ends at block 536 if the value of loop parameter i is greater than K; occurrence of this condition indicates that the K sequences enqueued on the priority queue are a set of top-K sequential patterns learned by the trained model 148.

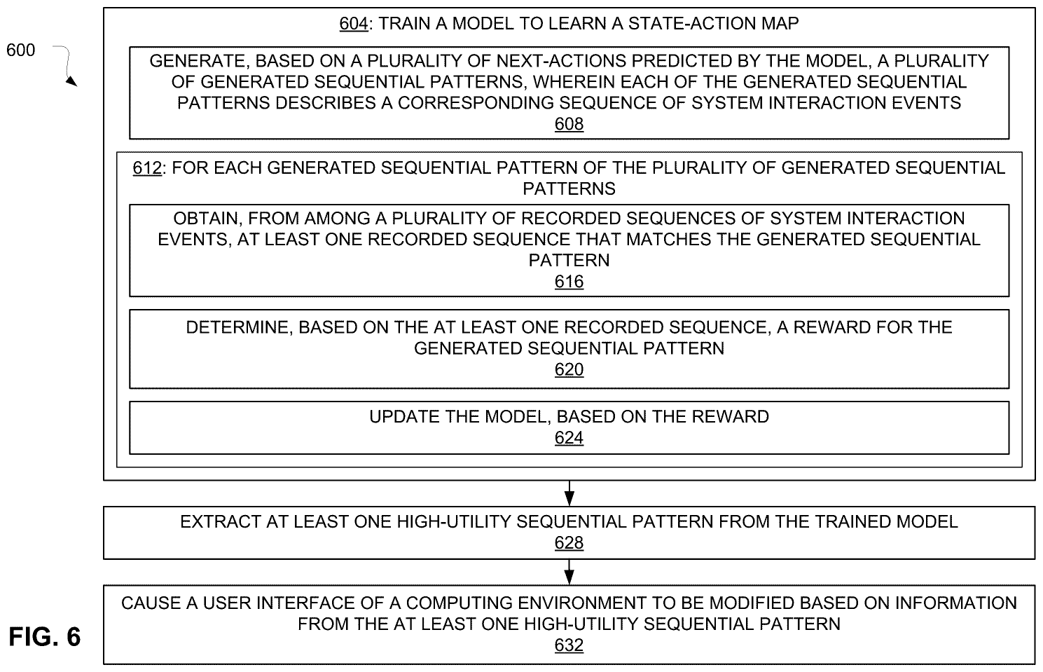

FIG. 6 depicts an example of a process 600 for training a model to learn a state-action map that contains high-utility sequential patterns and in some cases causing a user interface of a computing environment to be modified, according to certain embodiments of the present disclosure. One or more computing devices (e.g., the pattern-mining computing system 110) implement operations depicted in FIG. 6 by executing suitable program code. For illustrative purposes, the process 600 is described with reference to certain examples depicted in the figures. Other implementations, however, are possible.

At block 604, the process involves training a machine learning model to learn a state-action map that contains high-utility sequential patterns. Block 604 includes sub-blocks 608 and 612. At block 608, the process involves generating, based on a plurality of next-actions predicted by the machine learning model, a plurality of generated sequential patterns, wherein each generated sequential pattern of the plurality of generated sequential patterns describes a corresponding sequence of system interaction events.

Block 612 includes sub-blocks 616, 620, and 624. At block 616, the process involves obtaining, for each generated sequential pattern of the plurality of generated sequential patterns, and from among a plurality of recorded sequences of system interaction events, at least one recorded sequence that matches the generated sequential pattern. At block 620, the process involves determining, for each generated sequential pattern of the plurality of generated sequential patterns, and based on the corresponding at least one recorded sequence, a reward for the generated sequential pattern. At block 624, the process involves, for each generated sequential pattern of the plurality of generated sequential patterns, updating the machine learning model based on the corresponding reward.

At block 628, the process involves extracting at least one high-utility sequential pattern from the trained machine learning model. At block 632, the process involves causing a user interface of a computing environment to be modified based on information from the at least one high-utility sequential pattern.

### Example of a Computing System for Implementing Certain Embodiments

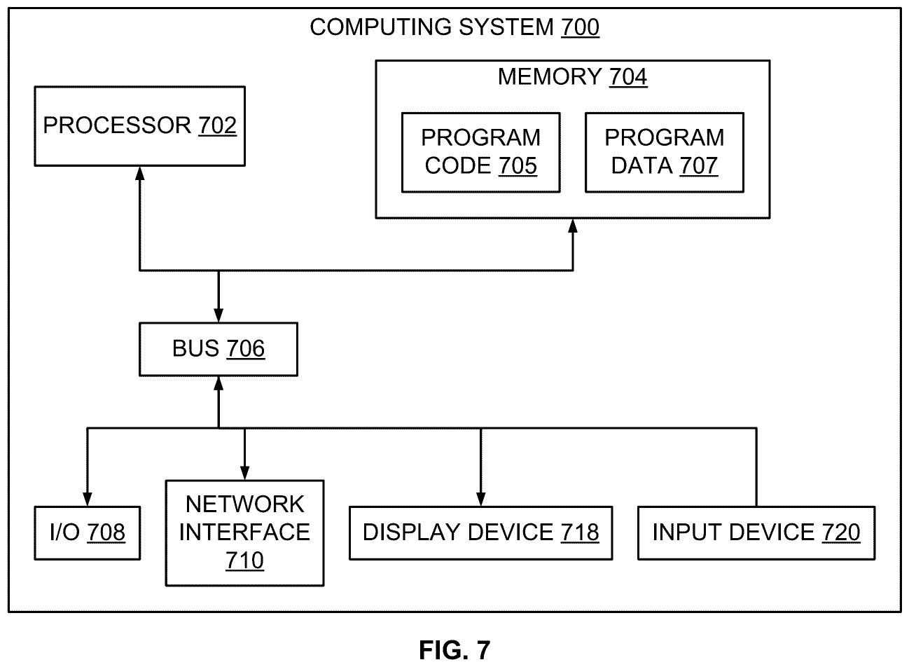

Any suitable computing system or group of computing systems can be used for performing the operations described herein. Although the reinforcement learning server 120, the pattern-extracting server 150, and the interface-modification server 160 are described as different servers, the functions of these servers may be implemented using any number of machines, including one (e.g., may be implemented using one or more machines). For example, FIG. 7 depicts an example of the computing system 700, according to certain embodiments of the present disclosure. The implementation of computing system 700 could be used to implement a reinforcement learning server 120, a pattern-extracting server 150, or a interface-modification server 160. In other embodiments, a single computing system 700 having devices similar to those depicted in FIG. 7 (e.g., a processor, a memory, etc.) combines the one or more operations and data stores depicted as separate systems in FIG. 1.

The depicted example of a computing system 700 includes a processor 702 communicatively coupled to one or more memory devices 704. The processor 702 executes computer-executable program code stored in a memory device 704, accesses information stored in the memory device 704, or both. Examples of the processor 702 include a microprocessor, an application-specific integrated circuit (ASIC), a field-programmable gate array (FPGA), or any other suitable processing device. The processor 702 can include any number of processing devices, including a single processing device.

A memory device 704 includes any suitable non-transitory computer-readable medium for storing program code 705, program data 707, or both. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript.

The computing system 700 executes program code 705 that configures the processor 702 to perform one or more of the operations described herein. Examples of the program code 705 include, in various embodiments, the application executed by the reinforcement learning server 116 to train the machine learning model 148, the application executed by the pattern-extracting server 150 to extract at least one high-value sequential pattern from the trained machine learning model 148, the application executed by the interface-modification server 160 to modify the user interface of the computing environment, or other suitable applications that perform one or more operations described herein. The program code may be resident in the memory device 704 or any suitable computer-readable medium and may be executed by the processor 702 or any other suitable processor.

In some embodiments, one or more memory devices 704 stores program data 707 that includes one or more datasets and models described herein. Examples of these datasets include interaction data, performance data, etc. In some embodiments, one or more of data sets, models, and functions are stored in the same memory device (e.g., one of the memory devices 704). In additional or alternative embodiments, one or more of the programs, data sets, models, and functions described herein are stored in different memory devices 704 accessible via a data network. One or more buses 706 are also included in the computing system 700. The buses 706 communicatively couple one or more components of a respective one of the computing system 700.

In some embodiments, the computing system 700 also includes a network interface device 710. The network interface device 710 includes any device or group of devices suitable for establishing a wired or wireless data connection to one or more data networks. Non-limiting examples of the network interface device 710 include an Ethernet network adapter, a modem, and/or the like. The computing system 700 is able to communicate with one or more other computing devices (e.g., a user computing device 190) via a data network using the network interface device 710.

The computing system 700 may also include a number of external or internal devices, an input device 720, a presentation device 718, or other input or output devices. For example, the computing system 700 is shown with one or more input/output (I/O) interfaces 708. An I/O interface 708 can receive input from input devices or provide output to output devices. An input device 720 can include any device or group of devices suitable for receiving visual, auditory, or other suitable input that controls or affects the operations of the processor 702. Non-limiting examples of the input device 720 include a touchscreen, a mouse, a keyboard, a microphone, a separate mobile computing device, etc. A presentation device 718 can include any device or group of devices suitable for providing visual, auditory, or other suitable sensory output. Non-limiting examples of the presentation device 718 include a touchscreen, a monitor, a speaker, a separate mobile computing device, etc.

Although FIG. 7 depicts the input device 720 and the presentation device 718 as being local to the computing device that executes the one or more applications noted above, other implementations are possible. For instance, in some embodiments, one or more of the input device 720 and the presentation device 718 can include a remote client-computing device that communicates with the computing system 700 via the network interface device 710 using one or more data networks described herein.

General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Additionally, the use of “or” is meant to be open and inclusive, in that “or” includes the meaning “and/or” unless specifically directed otherwise. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alternatives to, variations of, and equivalents to such embodiments. Accordingly, it should be understood that the present disclosure has been presented for purposes of example rather than limitation, and does not preclude the inclusion of such modifications, variations, and/or additions to the present subject matter as would be readily apparent to one of ordinary skill in the art.

1. A method comprising:
training, by a reinforcement learning server, a machine learning model to learn a state-action map that contains high-value sequential patterns, comprising:
generating, by an agent module and based on a plurality of next-actions predicted by the machine learning model, a plurality of generated sequential patterns, wherein each of the plurality of generated sequential patterns describes a corresponding sequence of system interaction events; and
for each generated sequential pattern of the plurality of generated sequential patterns:
obtaining, by an environment module and from among a plurality of recorded sequences of system interaction events, at least one recorded sequence that matches the generated sequential pattern;
determining, by the environment module and based on the at least one recorded sequence, a reward for the generated sequential pattern; and
updating the machine learning model, by the agent module and based on the reward;
extracting, by a pattern-extracting server, at least one high-value sequential pattern from the trained machine learning model; and
causing a user interface of a computing environment to be modified based on information from the at least one high-value sequential pattern.

2. The method of claim 1, wherein the system interaction events among the plurality of recorded sequences of system interaction events include click events or entity-initiated communications.

3. The method of claim 1, wherein, for each generated sequential pattern of the plurality of generated sequential patterns, determining the reward is based on a utility measure that is not anti-monotonic.

4. The method of claim 1, wherein, for each generated sequential pattern of the plurality of generated sequential patterns, determining the reward is based on a utility measure that indicates an average value across a plurality of products.

5. The method of claim 1, wherein, for at least one generated sequential pattern of the plurality of generated sequential patterns, generating the generated sequential pattern comprises selecting a next-action of the generated sequential pattern at random.

6. The method of claim 1, wherein each generated sequential pattern of the plurality of generated sequential patterns ends with a stop action.

7. The method of claim 1, wherein the machine learning model comprises a deep neural network.

8. The method of claim 1, wherein extracting the at least one high-value sequential pattern from the trained machine learning model comprises searching the trained machine learning model using a depth-first-search algorithm.

9. The method of claim 1, wherein, for each of the plurality of generated sequential patterns, each of the corresponding sequence of system interaction events comprises a plurality of attributes.

10. The method of claim 9, wherein the machine learning model includes a long short-term memory network and a Q-network.

11. A non-transitory computer-readable medium having program code that is stored thereon, the program code executable by one or more processing devices for performing operations comprising:
training a machine learning model to learn a state-action map that contains high-utility sequential patterns, comprising:
generating, based on a plurality of next-actions predicted by the machine learning model being trained, a plurality of generated sequential patterns, wherein each of the plurality of generated sequential patterns describes a corresponding sequence of system interaction events and ends with a stop action; and
for each generated sequential pattern of the plurality of generated sequential patterns:
obtaining, from among a plurality of recorded sequences of system interaction events, at least one recorded sequence that matches the generated sequential pattern;
determining, based on the at least one recorded sequence and a utility measure that is not anti-monotonic, a reward for the generated sequential pattern; and
updating the machine learning model based on the reward;
extracting at least one high-utility sequential pattern from the trained machine learning model; and
causing a user interface of a computing environment to be modified based on information from the at least one high-utility sequential pattern.

12. The non-transitory computer-readable medium of claim 11, wherein the system interaction events among the plurality of recorded sequences of system interaction events include click events or entity-initiated communications.

13. The non-transitory computer-readable medium of claim 11, wherein the utility measure indicates an average value across a plurality of products.

14. The non-transitory computer-readable medium of claim 11, wherein, for at least one generated sequential pattern of the plurality of generated sequential patterns, generating the generated sequential pattern comprises selecting a next-action of the generated sequential pattern at random.

15. The non-transitory computer-readable medium of claim 11, wherein extracting the at least one high-utility sequential pattern from the trained machine learning model comprises searching the trained machine learning model using a depth-first-search algorithm.

16. A system comprising:
a reinforcement learning module configured to train a machine learning model to learn a state-action map that contains high-utility sequential patterns, comprising:
an agent module configured to generate, based on a plurality of next-actions predicted by the machine learning model being trained, a plurality of generated sequential patterns, wherein each of the plurality of generated sequential patterns describes a corresponding sequence of system interaction events and ends with a stop action; and
an environment module configured to, for each generated sequential pattern of the plurality of generated sequential patterns:
obtain, from among a plurality of recorded sequences of system interaction events stored in a data store, at least one recorded sequence that matches the generated sequential pattern; and
determine, based on the at least one recorded sequence and a utility measure that is not anti-monotonic, a reward for the generated sequential pattern,
wherein the agent module is further configured to, for each generated sequential pattern of the plurality of generated sequential patterns, update the machine learning model based on the corresponding reward;
a pattern-extracting module configured to extract a plurality of high-utility sequential patterns from the trained machine learning model; and
an interface-modification server configured to cause a user interface of a computing environment to be modified based on information from the plurality of high-utility sequential patterns.

17. The system of claim 16, wherein the system interaction events among the plurality of recorded sequences of system interaction events include click events or entity-initiated communications.

18. The system of claim 16, wherein the utility measure indicates an average value across a plurality of products.

19. The system of claim 16, wherein the agent module is configured to generate, for at least one generated sequential pattern of the plurality of generated sequential patterns, the generated sequential pattern by selecting at least one next-action of the generated sequential pattern at random.

20. The system of claim 16, wherein the pattern-extracting module is configured to extract the at least one high-utility sequential pattern from the trained machine learning model by using a depth-first-search algorithm to search the trained machine learning model.
